(19) United States
(12) Patent Application Publication
(10) Pub. No.: US 2021/0331628 A1
(43) Pub. Date: Oct. 28, 2021

(54) A-PILLAR DISPLAY DEVICE, A-PILLAR DISPLAY METHOD, AND NON-TRANSITORY MEDIUM

(71) Applicant: TRIPLE WIN TECHNOLOGY(SHENZHEN) CO.LTD., Shenzhen (CN)

(72) Inventors: CHE-MING LIU, New Taipei (TW); LIANG-KAO CHANG, New Taipei (TW)

(21) Appl. No.: 16/889,267

(22) Filed: Jun. 1, 2020

(30) Foreign Application Priority Data
Apr. 26, 2020 (CN) 202010338518.1

(51) Int. Cl. B60R 11/02; B60R 11/04; B60K 35/00; G06F 3/01; G06K 9/00

(52) U.S. Cl. CPC B60R 11/0235; B60R 11/04; B60R 2011/0003; G06F 3/013; G06K 9/00845; B60K 35/00

(57) ABSTRACT

An A-pillar display device includes an interior camera, an exterior camera, a display, and a processor. The interior camera is mounted on an A-pillar inside a vehicle and configured to acquire facial images of a driver while driving. The exterior camera is mounted on the A-pillar outside the vehicle and configured to acquire a scene outside the vehicle. The display is mounted on the A-pillar inside the vehicle and configured to display the scene. The processor is configured to calculate head twisting data and visual field data according to the facial images, adjust a first shooting angle of the interior camera according to the head twisting data, and adjust a second shooting angle of the exterior camera according to the visual field data.

### FIELD

The subject matter herein generally relates to display technologies, and more particularly to an A-pillar display device, an A-pillar display method, and a non-transitory medium implementing the A-pillar display method.

### BACKGROUND

Generally, vehicles have blind spots caused by the A-pillar. Some vehicles have a screen embedded in the A-pillar inside the vehicle, the screen displays a scene acquired by an exterior camera mounted on the A-pillar outside the vehicle. However, the exterior camera generally acquires the scene at a fixed-angle, and the driver's head may need to twist during driving, resulting in different blind spots caused by the A-pillar.

### BRIEF DESCRIPTION OF THE DRAWINGS

Implementations of the present disclosure will now be described, by way of embodiments, with reference to the attached figures.

FIG. 1 is a schematic diagram of an embodiment of an A-pillar display device.

FIG. 2 is a flowchart of an embodiment of an A-pillar display method.

FIG. 3 is a schematic block diagram of the A-pillar display device in FIG. 1.

FIG. 4 is a schematic block diagram of function modules of an A-pillar display system.

### DETAILED DESCRIPTION

It will be appreciated that for simplicity and clarity of illustration, where appropriate, reference numerals have been repeated among the different figures to indicate corresponding or analogous elements. Additionally, numerous specific details are set forth in order to provide a thorough understanding of the embodiments described herein. However, it will be understood by those of ordinary skill in the art that the embodiments described herein can be practiced without these specific details. In other instances, methods, procedures and components have not been described in detail so as not to obscure the related relevant feature being described. The drawings are not necessarily to scale and the proportions of certain parts may be exaggerated to better illustrate details and features. The description is not to be considered as limiting the scope of the embodiments described herein.

Several definitions that apply throughout this disclosure will now be presented.

The term “coupled” is defined as connected, whether directly or indirectly through intervening components, and is not necessarily limited to physical connections. The connection can be such that the objects are permanently connected or releasably connected. The term “comprising” means “including, but not necessarily limited to”; it specifically indicates open-ended inclusion or membership in a so-described combination, group, series and the like.

In general, the word “module” as used hereinafter refers to logic embodied in hardware or firmware, or to a collection of software instructions, written in a programming language such as, for example, Java, C, or assembly. One or more software instructions in the modules may be embedded in firmware such as in an erasable-programmable read-only memory (EPROM). It will be appreciated that the modules may comprise connected logic units, such as gates and flip-flops, and may comprise programmable units, such as programmable gate arrays or processors. The modules described herein may be implemented as either software and/or hardware modules and may be stored in any type of computer-readable medium or other computer storage device.

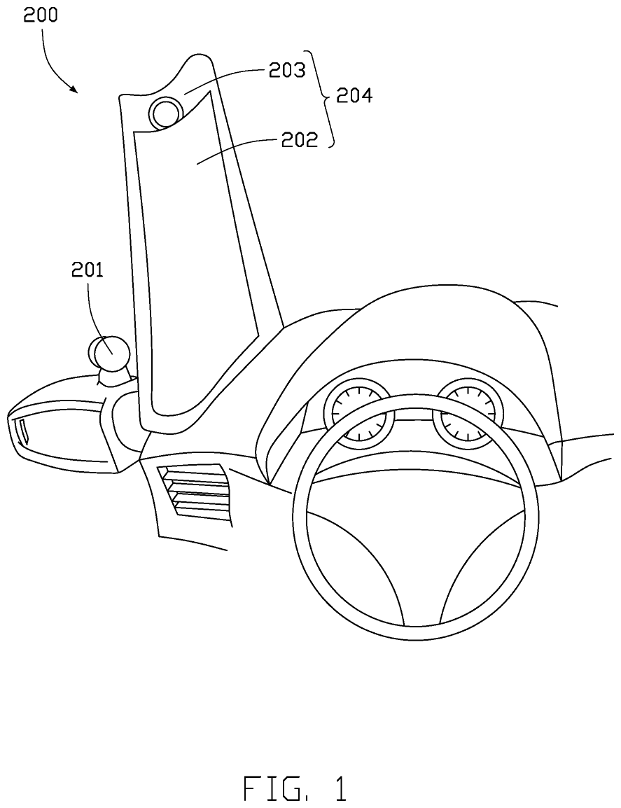

FIG. 1 shows an embodiment of an A-pillar display device 200 including a data processing device (not shown), a first display 202, a second display (not shown), a first exterior camera 201, and a second exterior camera (not shown). The first display 202 is mounted on an inclined surface of an A-pillar 204 on the driver side of a vehicle. The second display is mounted on a passenger-side A-pillar (not shown) of the vehicle. The first exterior camera 201 is mounted on the A-pillar 204 on the outside of the vehicle. The second exterior camera is mounted on the passenger-side A-pillar on the outside of the vehicle. The A-pillar display device 200 further includes a first interior camera 203 and a second interior camera (not shown). The first interior camera 203 is mounted on the A-pillar 204 above the first display 202. The second interior camera is mounted on the passenger-side A-pillar above the second display. The first display 202, the second display, the first exterior camera 201, the second exterior camera, the first interior camera 203, and the second interior camera are electrically connected to the data processing device. The data processing device stores an algorithm corresponding to the set of devices and performs data processing through the algorithm. In another embodiment, the first exterior camera 201 and the second exterior camera may be mounted on the side-view mirrors, respectively.

Specifically, the data processing device is configured to calculate head twisting data, visual field data, and driving data based on facial images collected by the first interior camera 203 and the second interior camera. The data processing device is configured to adjust a first shooting angle of the first interior camera 203 and the second interior camera according to the head twisting data, adjust a second shooting angle of the first exterior camera 201 and the second exterior camera according to the visual field data, and adjust a display angle of the A-pillar 204 according to the driving data. Thus, the first exterior camera 201, the second exterior camera, the first interior camera 203, the second interior camera, the first display 202, and the second display can be rotated for use by different drivers.

In at least one embodiment, the first interior camera 203 and the second interior camera are used to acquire a driver's facial image, and the first exterior camera 201 and the second exterior camera are used to acquire a scene outside the vehicle. The first display 202 and the second display are used to display the scene. Specifically, the first exterior camera 201 acquires a first scene based on the visual field data corresponding to the first interior camera 203, and displays the first scene on the first display 202. The second exterior camera collects a second scene based on the visual field data corresponding to the second interior camera, and displays the second scene on the second display.

The A-pillar display device 200 adjusts the shooting angle of the cameras in the vehicle according to the driver's head twisting data while driving, which improves the accuracy of collecting facial images, and thereby improves the accuracy of calculating the visual field data. In addition, the shooting angle of the cameras outside the vehicle is adjusted according to the visual field data, which is suitable for targeting blind spots for different drivers. Finally, the display angle of the A-pillar 204 of the vehicle is adjusted according to the driving data, which can be adjusted according to the human eye position of different drivers during normal driving.

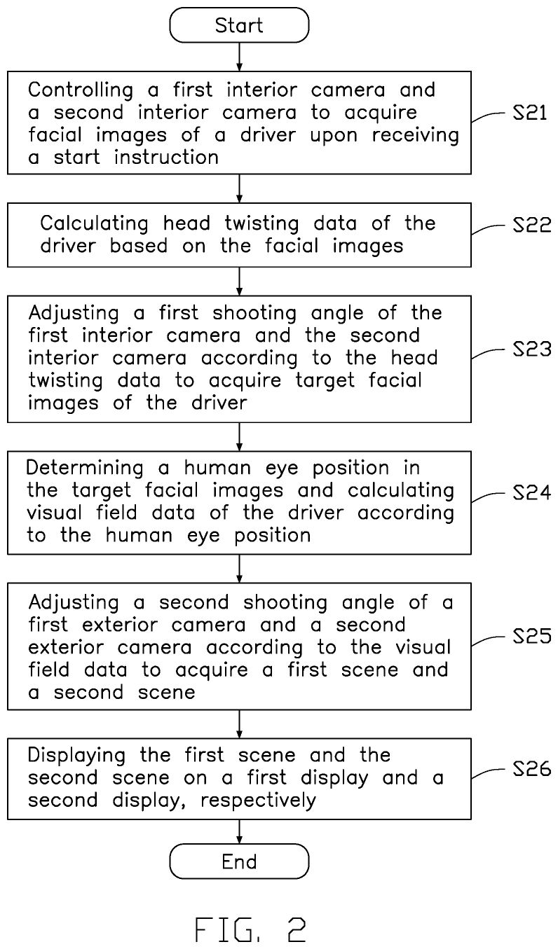

FIG. 2 is a flowchart of an A-pillar display method based on the A-pillar display device 200. According to different requirements, the execution order of the blocks in the flowchart shown can be changed, and some blocks can be omitted. The

A-pillar display method includes the following blocks:

Block S21: when the data processing device receives a start instruction, the data processing device controls the first interior camera 203 and the second interior camera to collect a driver's facial images.

In at least one embodiment, the start instruction may include an instruction output by the driver (for example, voice input, touch input, etc.), a car driving instruction (that is, a car start instruction), and the like, which is not limited herein. The data processing device controls the first interior camera 203 and the second interior camera to acquire the driver's facial image at the same time upon receiving the start instruction.

In at least one embodiment, after acquiring the driver's facial image, the method further includes: detecting whether a facial area image is acquired in the facial image according to a preset facial detection algorithm. When the facial area image is acquired, whether the facial area image includes a human eye position is detected. When the detection result is that the facial area image does not include the human eye position, the target camera group corresponding to the facial image that does not include the human eye position is determined, and the target camera group is controlled to acquire the scene at the current shooting angle. It can be understood that when the detection result is that the facial area image does not include the human eye position, the driver's line of sight cannot be detected, that is, the driver's line of sight is blocked by obstacles. The corresponding target camera group at this time can acquire images at a fixed angle, and the corresponding display screen also displays the scene at a fixed angle.

In at least one embodiment, a preset pre-trained facial detection algorithm is used for detecting the facial area image in the facial image and the human eye position in the facial area image. The preset pre-trained facial detection algorithm may include a SeetaFacial detection algorithm, which is an automatic facial recognition algorithm based on the C++ language. The SeetaFacial detection algorithm may include a FaceDetection facial detection module and a FaceAlignment feature point positioning module. Specifically, the FaceDetection facial detection module is first used for performing facial detection to obtain a rectangular frame including the entire face. Then, the FaceAlignment feature point positioning module is used for locating the two feature points of the center of the eyes of the face and obtaining the coordinates of the center of the eyes.

In at least one embodiment, after obtaining the facial area image, the method further includes: traversing a preset facial image database according to the facial area image to determine target driving data. Based on the target driving data, the display angle on the A-pillar 204 is adjusted. The preset facial image database contains facial area images and driving data corresponding to the facial images. The driving data may include the height, body shape, and position of the human eye during normal driving. The display angle of the A-pillar 204 is adjusted according to the driving data.

Block S22: the driver's head twisting data is calculated based on the facial images.

In at least one embodiment, the calculation of the driver's head twisting data based on the facial image includes: obtaining first coordinate information of preset facial key points in a current video frame, obtaining second coordinate information of the same preset facial key points in a previous video frame, and calculating the driver's head twisting data according to the first coordinate information and the second coordinate information.

The preset facial key points may include one or a combination of the following: eyebrows, nose, eyes, and mouth. In one embodiment, there are ten key points for the eyebrows corresponding to the numbers 1-10, nine key points for the nose corresponding to the numbers 11-19, twelve key points for the eyes corresponding to the numbers 20-31, and twenty key points for the mouth corresponding to the numbers 32-51. The coordinate information includes 2D coordinate information and 3D coordinate information. The 2D coordinate information may be 2D coordinate information of the preset facial key points in a video frame coordinate system, and the 3D coordinate information may be 3D coordinate information of the preset facial key points in a camera coordinate system.

Block S23: the first shooting angle of the first interior camera 203 and the second interior camera is adjusted according to the head twisting data to acquire target facial images of the driver.

During a driving process, the driver's head may be twisted so as to keep track of road conditions at any time. If the first interior camera 203 and the second interior camera keep a fixed shooting angle, the visual field data may not be acquired accurately, which reduces the vehicle's display capability. Therefore, the shooting angle is adjusted according to the head twisting data to ensure that the facial image is acquired accurately.

In at least one embodiment, a method of adjusting the first shooting angle of the first interior camera 203 and the second interior camera according to the head twisting data includes: obtaining the current shooting angle of the first interior camera 203 and the second interior camera, determining head twisting data corresponding to the current shooting angle according to a mapping relationship between a preset shooting angle and preset head twisting data, and detecting whether the head twisting data exceeds the preset head twisting data. When the head twisting data exceeds the preset head twisting data, a head twisting difference between the head twisting data and the preset head twisting data is calculated, and the first shooting angle of the first interior camera 203 and the second interior camera is adjusted according to the head twisting difference.

Block S24: the human eye position in the target facial images is determined, and the visual field data of the driver is calculated according to the human eye position.

In at least one embodiment, a method of determining the human eye position in the target facial image and calculating the visual field data of the driver according to the human eye position includes: detecting a facial position of the target facial image in each frame according to a preset human face detection algorithm to obtain a facial area image, locating the human eye position in the facial area image, obtaining pupil positions according to the human eye position, calculating an eye movement trajectory parameter corresponding to the pupil positions in each frame, and calculating the driver's visual field data according to the eye movement trajectory parameter.

In at least one embodiment, a method for locating the human eye position in the facial area image may include: determining the position of the human eye using gray-scale integral projection or determining the position of the human eye using a template matching method. Among them, the gray-scale integral projection is used to determine the position of the human eyes. After accurately positioning the facial area, according to the facial organ distribution of the face, the human eyes are in the upper half of the face. First, the upper half of the facial area is intercepted for processing. The gray value of the eye part in the facial area image is usually less than the gray value of the surrounding area, and the feature is often used to locate the eyes by using the integral projection method. The template matching method is used to determine the position of the human eyes. The template matching method defines the size of the image S to be searched as width W and height H, and the size of the template T as width M and height N. The image S to be searched is searched for a sub-picture having a similar size, square, and image as the template T, and its coordinate position is determined.

Block S25: the second shooting angle of the first exterior camera 201 and the second exterior camera is adjusted according to the visual field data to acquire a first scene and a second scene.

In at least one embodiment, the first scene and the second scene include a scene of a blind spot caused by the A-pillar 204 and other scenes. It can be understood that the shooting angle of the exterior cameras can be adjusted according to the visual field data for compensating the blind spots.

Block S26: the first scene and the second scene are displayed on the first display 202 and the second display, respectively.

In at least one embodiment, the first display 202 and the second display are respectively used to display the scenes captured by the first exterior camera 201 and the second exterior camera. In one embodiment, the first display 202 and the second display only display the scenes obstructed by the blind spots caused by the A-pillar 204, so that the driver can view a continuous scene through the windows and the A-pillar 204.

Specifically, before displaying the first scene and the second scene on the first display 204 and the second display, the method further includes: obtaining the visual field data, determining the blind spots according to the visual field data caused by the A-pillar 204, determining a third shooting angle according to the blind spots, obtaining the first scene and the second scene corresponding to the third shooting angle, and displaying the first scene and the second scene respectively on the first display 204 and the second display. The third shooting angle is a shooting angle corresponding to the blind spots.

According to the A-pillar display method based on the A-pillar display device 200, the shooting angle of the interior cameras is adjusted according to the driver's head twisting during driving, which can improve the accuracy of acquiring facial images. Determining the human eye position according to the facial images can improve the accuracy of the visual field data. In addition, the shooting angle of the exterior cameras is adjusted according to the visual field data.

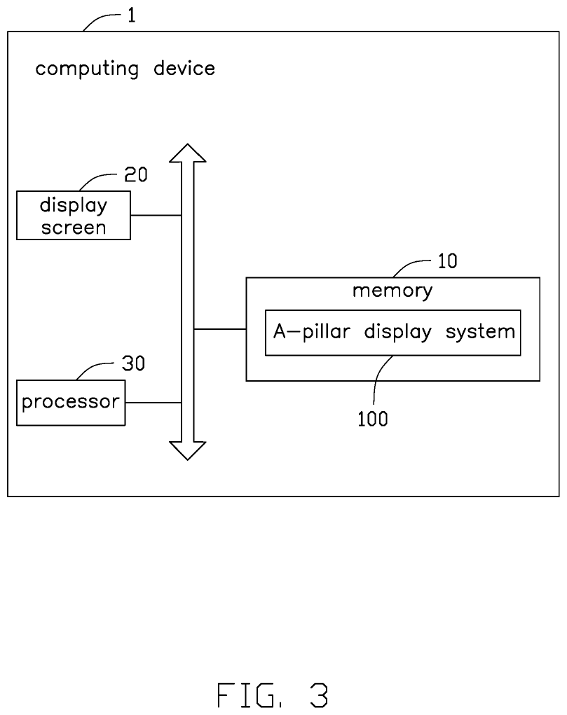

FIG. 3 is a schematic structural diagram of a computing device 1. As shown in FIG. 3, the computing device 1 includes a memory 10 in which a A-pillar display system 100 is stored. The computing device 1 may be an electronic device with functions such as data processing, analysis, program execution, and display, such as a computer, a tablet computer, and a personal digital assistant. The A-pillar display system 100 may control the first interior camera 203 and the second interior camera to collect the driver's facial image when the data processing device receives the start instruction, calculate the driver's head twisting data, adjust the first shooting angle of the first interior camera 203 and the second interior camera according to the head twisting data, determine the human eye position in the target facial image and calculate the visual field data of the driver according to the human eye position, adjust the second shooting angle of the first exterior camera 201 and the second exterior camera to acquire the first scene and the second scene, and display the first scene and the second scene on the first display 202 and the second display. The shooting angle of the interior cameras is adjusted according to the driver's head twisting during driving, which can improve the accuracy of acquiring facial images. Determining the human eye position according to the facial image can improve the accuracy of the visual field data. In addition, the shooting angle of the exterior cameras is adjusted according to the visual field data, which can fill in the blind spots for different drivers.

In one embodiment, the computing device 1 may further include a display screen 20 and a processor 30. The memory 10 and the display screen 20 may be electrically connected to the processor 30.

The memory 10 may be different types of storage devices for storing various types of data. For example, it may be the memory or internal memory of the computing device 1, or a memory card that can be externally connected to the computing device 1, such as a flash memory, Smart Media Card, and Secure Digital Card. In addition, the memory 10 may include non-volatile memory, such as a hard disk, a memory, a plug-in hard disk, a smart memory card, a secure digital card, a flash memory card, at least one magnetic disk storage device, flash memory device, or other non-volatile solid-state storage device. The memory 10 is used to store various types of data, for example, various types of applications installed in the computing device 1, a data set acquired by the above-described A-pillar display method, and other information.

The display screen 20 is installed on the computing device 1 for displaying information.

The processor 30 is used to execute the A-pillar display method and various types of software installed in the computing device 1, such as an operating system and application display software. The processor 30 includes, but is not limited to, a Central Processing Unit, a micro controller unit, and other devices for interpreting computer instructions and processing data in computer software.

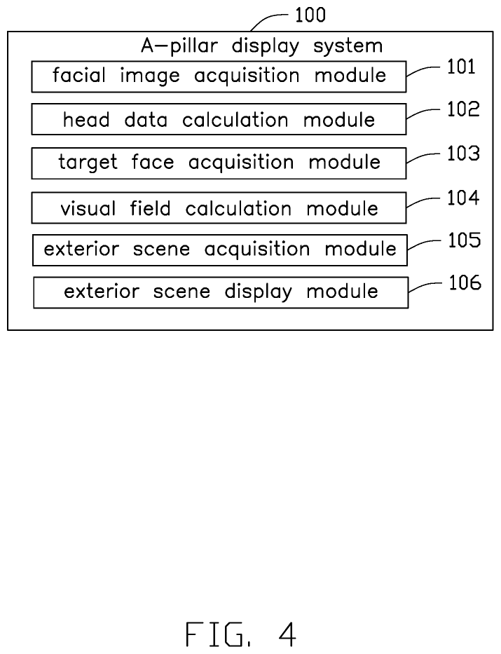

The A-pillar display system 100 may include one or more modules, which are stored in the memory 10 of the computing device 1 and executed by one or more processors (such as the processor 30). For example, referring to FIG. 4, the A-pillar display system 100 may include a facial image acquisition module 101, a head data calculation module 102, a target face acquisition module 103, a visual field data calculation module 104, an exterior scene acquisition module 105, and an exterior scene display module 106.

The facial image acquisition module 101 is configured to control the first interior camera 203 and the second interior camera to acquire the driver's facial image upon receiving the start instruction.

The head data calculation module 102 is configured to calculate the driver's head twisting data based on the facial image.

The target face acquisition module 103 is configured to adjust the first shooting angle of the first interior camera 203 and the second interior camera according to the head twisting data to acquire the target facial image of the driver.

The visual field data calculation module 104 is configured to determine the human eye position in the target facial image and calculate the visual field data of the driver according to the human eye position.

The exterior scene acquisition module 105 is configured to adjust the second shooting angle of the first exterior camera 201 and the second exterior camera according to the visual field data to acquire the first scene and the second scene.

The exterior scene display module 106 is configured to display the first scene and the second scene on the first display 202 and the second display, respectively.

The present disclosure further provides a computer-readable storage medium on which a computer program is stored, and when the computer program is executed by the processor 30, the blocks of the A-pillar display method are implemented.

If the A-pillar display system 100/computing device 1 is implemented in the form of a software functional unit and sold or used as an independent product, it can be stored in a computer-readable storage medium. Based on this understanding, the present disclosure can implement all or part of the processes in the methods of the above embodiments, and can also be completed by a computer program instructing relevant hardware. The computer program can be stored in a computer-readable storage medium.

When the program is executed by the processor 30, the blocks of the foregoing method may be implemented. Wherein, the computer program includes computer program code, and the computer program code may be in a source code form, an object code form, an executable file, or some intermediate form, etc. The computer-readable storage medium may include any entity or device capable of carrying the computer program code, a recording medium, a U disk, a mobile hard disk, a magnetic disk, an optical disk, a computer memory, a read-only memory, etc.

The processor 30 may be a central processing unit or other general-purpose processor, digital signal processors, application specific integrated circuit, Field-programmable gate array, or other programmable logic devices, discrete gate or transistor logic devices, discrete hardware components, etc. The general-purpose processor may be a microprocessor or the processor may also be any conventional processor, etc. The processor 30 is the control center of the A-pillar display system 100 / computing device 1 using various interfaces and lines to connect the various parts of the entire A-pillar display system 100/computing device 1.

The memory 10 is used to store the computer program and/or modules, the processor 30 executes the computer program and/or modules stored in the memory 10 and calls the data stored in the memory 10, various functions of the A-pillar display system 100/computing device 1 are realized. The memory 10 may mainly include a storage program area and a storage data area, wherein the storage program area may store an operating system, at least one function required application programs (such as sound playback function, image playback function, etc.); the storage data area may store data such as audio data created according to the use of the computing device 1.

The embodiments shown and described above are only examples. Even though numerous characteristics and advantages of the present technology have been set forth in the foregoing description, together with details of the structure and function of the present disclosure, the disclosure is illustrative only, and changes may be made in the detail, including in matters of shape, size and arrangement of the parts within the principles of the present disclosure up to, and including, the full extent established by the broad general meaning of the terms used in the claims.

What is claimed is:

1. An A-pillar display device comprising:
at least one interior camera mounted on an A-pillar inside a vehicle and configured to acquire facial images of a driver while driving;
at least one exterior camera mounted on the A-pillar outside the vehicle and configured to acquire a scene outside the vehicle;
at least one display mounted on the A-pillar inside the vehicle and configured to display the scene; and
a processor coupled to the at least one interior camera, the at least one exterior camera, and the at least one display, wherein the processor is configured to:
calculate head twisting data and visual field data according to the facial images;
adjust a first shooting angle of the at least one interior camera according to the head twisting data; and
adjust a second shooting angle of the at least one exterior camera according to the visual field data.

2. The A-pillar display device of claim 1, wherein:
the at least one exterior camera acquires the scene outside the vehicle according to the visual field data; and
the processor controls the at least one display to display the scene acquired by a respective one of the at least one exterior camera.

3. An A-pillar display method comprising:
controlling at least one interior camera to acquire facial images of a driver upon receiving a start instruction;
calculating head twisting data based on the facial images;
adjusting a first shooting angle of the at least one interior camera according to the head twisting data to acquire target facial images of the driver;
determining a human eye position in the target facial images, and calculating visual field data of the driver according to the human eye position;
adjusting a second shooting angle of at least one exterior camera according to the visual field data to acquire a respective at least one scene; and
displaying the at least one scene on a respective display on an A-pillar inside a vehicle.

4. The A-pillar display method of claim 3, wherein a method of determining the human eye position in the target facial images and calculating the visual field data of the driver according to the human eye position comprises:
detecting a facial position of the target facial images in each frame according to a preset human face detection algorithm to obtain a facial area image;
locating the human eye position in the facial area image;
obtaining pupil positions according to the human eye position and calculating an eye movement trajectory parameter corresponding to the pupil positions in each frame; and
calculating the visual field data according to the eye movement trajectory parameter.

5. The A-pillar display method of claim 4, wherein after obtaining the facial area image, the method further includes:
traversing a preset facial image database according to the facial area image to determine target driving data; and
adjusting a display angle on the A-pillar based on the target driving data.

6. The A-pillar display method of claim 3, wherein a method of adjusting the first shooting angle of the at least one interior camera according to the head twisting data comprises:
obtaining a current shooting angle of the at least one interior camera, determining head twisting data corresponding to the current shooting angle according to a mapping relationship between a preset shooting angle and preset head twisting data,
detecting whether the head twisting data exceeds the preset head twisting data;
when the head twisting data exceeds the preset head twisting data, calculating a head twisting difference between the head twisting data and the preset head twisting data; and
adjusting the first shooting angle of the at least one interior camera according to the head twisting difference

7. The A-pillar display method of claim 3, wherein before displaying the at least one scene on the respective display, the method further comprises:
obtaining the visual field data;
determining blind spots according to the visual field data caused by the A-pillar;
determining a third shooting angle according to the blind spots;
obtaining the at least one scene corresponding to the third shooting angle; and
displaying the at least one scene on the respective display.

8. The A-pillar display method of claim 3, wherein after acquiring the facial images of the driver, the method further comprises:
detecting whether a facial area image is acquired in the facial images according to a preset facial detection algorithm;
when the facial area image is acquired, detecting whether the facial area image comprises the human eye position;
when the facial area image does not comprise the human eye position, determining a target camera group corresponding to the facial image that does not comprise the human eye position; and
controlling the target camera group to acquire the at least one scene at the current shooting angle.

9. A non-transitory storage medium having stored thereon instructions that, when executed by a processor, causes the processor to perform an A-pillar display method, wherein the method comprises:
controlling at least one interior camera to acquire facial images of a driver upon receiving a start instruction;
calculating head twisting data based on the facial images;
adjusting a first shooting angle of the at least one interior camera according to the head twisting data to acquire target facial images of the driver;
determining a human eye position in the target facial images, and calculating visual field data of the driver according to the human eye position;
adjusting a second shooting angle of at least one exterior camera according to the visual field data to acquire a respective at least one scene; and
displaying the at least one scene on a respective display on an A-pillar inside a vehicle.

10. The non-transitory storage medium of claim 9, wherein a method of determining the human eye position in the target facial images and calculating the visual field data of the driver according to the human eye position comprises:
detecting a facial position of the target facial images in each frame according to a preset human face detection algorithm to obtain a facial area image;
locating the human eye position in the facial area image;
obtaining pupil positions according to the human eye position and calculating an eye movement trajectory parameter corresponding to the pupil positions in each frame; and
calculating the visual field data according to the eye movement trajectory parameter.

11. The non-transitory storage medium of claim 10, wherein after obtaining the facial area image, the method further includes:
traversing a preset facial image database according to the facial area image to determine target driving data; and
adjusting a display angle on the A-pillar based on the target driving data.

12. The non-transitory storage medium of claim 9, wherein a method of adjusting the first shooting angle of the at least one interior camera according to the head twisting data comprises:
obtaining a current shooting angle of the at least one interior camera,
determining head twisting data corresponding to the current shooting angle according to a mapping relationship between a preset shooting angle and preset head twisting data,
detecting whether the head twisting data exceeds the preset head twisting data;
when the head twisting data exceeds the preset head twisting data, calculating a head twisting difference between the head twisting data and the preset head twisting data; and
adjusting the first shooting angle of the at least one interior camera according to the head twisting difference

13. The non-transitory storage medium of claim 9, wherein before displaying the at least one scene on the respective display, the method further comprises:
obtaining the visual field data;
determining blind spots according to the visual field data caused by the A-pillar;
determining a third shooting angle according to the blind spots;
obtaining the at least one scene corresponding to the third shooting angle; and
displaying the at least one scene on the respective display.

14. The non-transitory storage medium of claim 9, wherein after acquiring the facial images of the driver, the method further comprises:
detecting whether a facial area image is acquired in the facial images according to a preset facial detection algorithm;
when the facial area image is acquired, detecting whether the facial area image comprises the human eye position;
when the facial area image does not comprise the human eye position, determining a target camera group corresponding to the facial image that does not comprise the human eye position; and
controlling the target camera group to acquire the at least one scene at the current shooting angle.
